(19) United States
(12) Patent Application Publication
(10) Pub. No.: US 2017/0012498 A1
(43) Pub. Date: Jan. 12, 2017

(54) MOTOR-DRIVING DEVICE WITH DETACHABLE RADIATOR

(71) Applicant: FANUC CORPORATION, Yamanashi (JP)

(72) Inventor: Masatomo Shirouzu, Yamanashi (JP)

(73) Assignee: FANUC CORPORATION, Yamanashi (JP)

(21) Appl. No.: 15/189,376

(22) Filed: Jun. 22, 2016

(30) Foreign Application Priority Data
Jul. 10, 2015 (JP) 2015-138954

(51) Int. Cl. H02K 9/00

(52) U.S. Cl. CPC H02K 9/005

(57) ABSTRACT

A motor-driving device includes a power element, a supporting body supporting the power element and a radiator detachably attached to the supporting body. The surface area of the contact surface between the back surface of the supporting body and the radiator is larger than the surface area of a reference contact surface when the supporting body and the radiator contact each other in a plane extending in a direction perpendicular to the attaching direction of the radiator.

### BACKGROUND OF THE INVENTION

The present invention relates to a motor-driving device with a radiator.

### DESCRIPTION OF THE RELATED ART

The heat generated by a heat source such as a power element used in a motor-driving device is transmitted to a radiator through a supporting body of the power element. The radiator releases heat to the surroundings by a cooling means such as fins. The radiator used in the motor-driving device is usually integrally formed with the supporting body of the heat source in view of heat conductivity. In such cases of a radiator integrated with a supporting body, when maintenance and inspection is carried out on the radiator it is necessary to remove the entire motor-driving device, and thus results in an increase in cost.

A technology which allows maintenance of a cooling unit without disassembling the main body of an electronic device, by a configuration in which the cooling unit is detachable from the main body, is well known (Japanese Unexamined Patent Publication (Kokai) 2006-013376).

### SUMMARY OF THE INVENTION

Compared to integrated radiators, the closeness of contact of detachable radiators to the main body of the motor-driving device is decreased and heat resistance is increased. Accordingly, the motor-driving device may overheat due to being unable to obtain a sufficient heat radiation effect, or the power element may break.

Therefore, there is a need for a motor-driving device in which maintenance and inspection of a radiator can be easily performed and which can achieve a sufficient heat radiation effect.

According to the first embodiment of the present invention, there is provided a motor-driving device comprising a heat source, a supporting body which supports the heat source and is formed of a heat conductive material, and a radiator which is detachably attached to the supporting body and which radiates heat transmitted through the supporting body from the heat source, wherein the surface area of the contact surface between the supporting body and the radiator is larger than the surface area of a reference contact surface when the supporting body contacts the radiator, in a plane extending in a direction perpendicular to the attaching direction of the radiator.

According to the second embodiment of the present invention, there is provided the motor-driving device of the first embodiment wherein the surface area of the contact surface, over the whole contact surface, is larger than the surface area of the reference contact surface.

According to the third embodiment of the present invention, there is provided the motor-driving device of the first or second embodiments wherein the increase in surface area of the contact surface with respect to the surface area of the reference contact surface changes in accordance with the distance from the heat source.

According to the fourth embodiment of the present invention, there is provided the motor-driving device of any one of the first to third embodiments further comprising an intermediate body which is formed of a material with a heat conductivity higher than air and which is provided between the supporting body and the radiator.

According to the fifth embodiment of the present invention, there is provided the motor-driving device of the fourth embodiment wherein the intermediate body is formed of a solid material.

According to the sixth embodiment of the present invention, there is provided the motor-driving device of any one of the first to fifth embodiments wherein a gap is formed in the contact surface by a recess formed on at least one of the supporting body and the radiator.

According to the seventh embodiment of the present invention, there is provided the motor-driving device of any one of the first to sixth embodiments wherein a threaded hole is formed which extends through the radiator in the attaching direction but does not extend through the supporting body.

### BRIEF DESCRIPTION OF THE DRAWINGS

The above mentioned objects, features, and advantages and other objects, features and advantages of the present invention will become more apparent from the following detailed description of the exemplary embodiments of the present invention illustrated in the accompanying drawings in which:

FIG. 1A is an exploded perspective view illustrating the motor-driving device according to an embodiment.

FIG. 1B is an exploded perspective view illustrating a variant of the motor-driving device of FIG. 1A.

FIG. 2 is a view illustrating the motor-driving device of FIG. 1 in which the radiator is attached to the supporting body in.

FIG. 3 is a side view illustrating the motor-driving device according to another embodiment.

FIG. 4 is a side view illustrating the motor-driving device according to yet another embodiment.

FIG. 5 is a side view illustrating the motor-driving device according to a further embodiment.

FIG. 6 is an enlarged view of the area X of FIG. 5.

FIG. 7 is an enlarged view of the area X of FIG. 5.

FIG. 8 is a rear view illustrating the motor-driving device according to a further embodiment.

FIG. 9 is a sectional view taken along the line IX-IX of FIG. 8.

FIG. 10 is a side view illustrating the motor-driving device according to a further embodiment.

FIG. 11 is a side view illustrating the motor-driving device according to a further embodiment.

FIG. 12 is a side view illustrating the motor-driving device according to a further embodiment.

FIG. 13 is a side view illustrating the motor-driving device according to a further embodiment.

FIG. 14 is an exploded perspective view illustrating a motor-driving device according to a comparative example.

### DETAILED DESCRIPTION

Hereinafter, embodiments of the present invention will be described referring to the drawings. The same reference numerals for the same or corresponding constitutional elements are used over the drawings. The scale of the drawings showing the constitutional elements of the illustrated embodiments has appropriately been adjusted so as to facilitate the understanding of the present inventions.

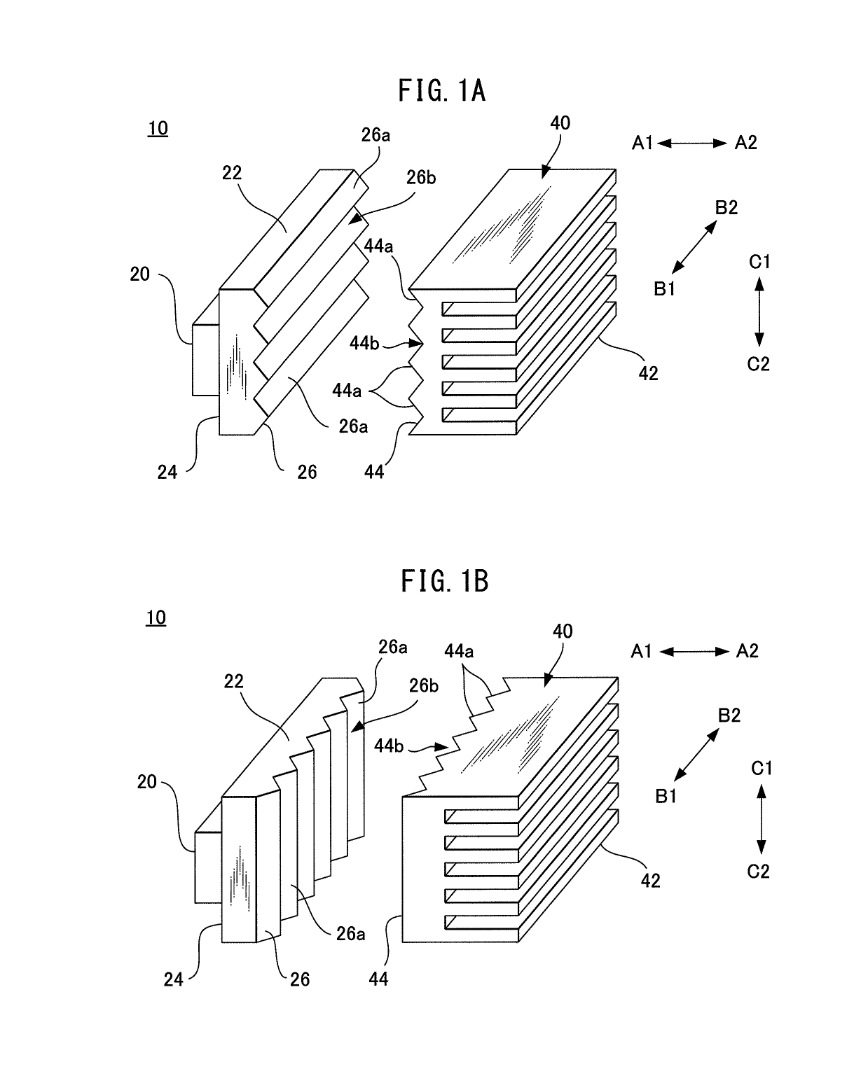

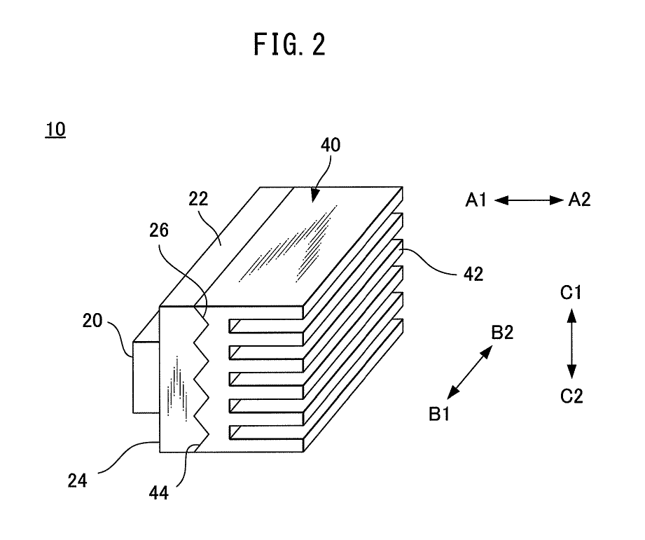

The motor-driving device 10 according to an embodiment will be described with reference to FIG. 1A and FIG. 2. The motor-driving device 10 is used to provide power to an unillustrated motor. The motor is used to drive a moving shaft or a main shaft of a machine tool, or a joint shaft of a robot. In the description of the following embodiments it is defined that the arrows A1 and A2 represent the forward and backward directions respectively, the arrows B1 and B2 represent the left and right directions respectively, and the arrows C1 and C2 represent the up and down directions respectively.

The motor-driving device 10 comprises a power element 20 and a supporting body 22 which supports the power element 20. For a motor-driving device 10 used for driving a machine tool or an industrial robot, in general it is necessary to deal with a large current. Accordingly, there is a tendency for the amount of heat generated from the power element 20 to increase. The motor-driving device is provided with a radiator 40 to cool the power element 20, which is a heat generating source.

The power element 20 is a semiconductor element used to control the power supplied to the motor. The power element 20 is provided with a switching element such as a transistor. The supporting body 22, supports on its front surface 24, a circuit board on which the power element 20 and other circuit components are mounted. The supporting body 22 is formed of a material with high heat conductivity such as copper, aluminum, or an alloy thereof. The back surface 26 of the supporting body 22 is formed so that the radiator 40 can be received thereon.

The radiator 40 is formed of a material with high heat conductivity, similar to the supporting body. The radiator 40 may be made of the same material as or a different material to the supporting body 22. The front surface 44 of the radiator 40 has a complementary shape with the back surface 26 of the supporting body 22 which is opposed thereto in the forward direction (mounting direction), so as to closely fit therewith. The radiator 40 is provided with a plurality of fins 42 formed thereon which protrude in a direction opposite the supporting body 22, that is, in a backward direction. The fins 42 are spaced from one another at distances in the up/down direction. Each fin 42 has a planar shape which extends in a direction substantially perpendicular to the forward and backward directions.

The fins 42 promote the heat exchange between the radiator 40 and the surrounding air.

Accordingly, the radiator 40 releases the heat generated by the power element 20 to the surroundings.

As shown in FIG. lA and FIG. 2, on the back surface 26 of the supporting body 22 opposing the radiator 40, a plurality of protrusions 26a which protrude backwards are formed and arrayed in the up/down direction. Recesses 26b recessed in the forward direction are formed between the adjacent protrusions 26a. The protrusions 26a and the recesses 26b extend in the left/right direction. Note that according to the alternative illustrated in FIG. B, the protrusions 26a and the recesses 26b may extend in a direction rotated by 90 degrees with respect to the array direction of the fins 42. In this case the plurality of protrusions 26a and the recesses 26b extending in the up/down directions are arranged in the left/right directions.

The front surface 44 of the radiator 40 opposing the supporting body 22 has a complementary shape to the back surface 26 of the supporting body 22. The front surface 44 has a plurality of protrusions 44a which protrude in the forward direction. Recesses 44b recessed in the backward direction are formed between the adjacent protrusions 44a. With reference to FIG. 2, when the radiator 40 is installed on the supporting body 22, the protrusions 26a and the recesses 26b of the supporting body 22 respectively engage with the recesses 40 and the protrusions 44a of the radiator 40. Accordingly, the supporting body 22 and the radiator 40 can be tightly in contact with each other.

As can be seen in FIG. 2, according to the present embodiment, the contact surface between the supporting body 22 and the radiator 40, as viewed from the left/right direction is serrated, increasing the contact surface area thereof.

FIG. 14 illustrates a comparative example of the motor-driving device 100. The back surface 126 of the supporting body 122 supports a power element 120 of the motor-driving device 100 is a plane expanding in a direction perpendicular to the forward/backward directions. Further, the front surface 144 of the radiator 140 that is located on the side opposite to the fins 142 is a plane expanding in a direction perpendicular to the front/back direction. Therefore, the contact surface area between the supporting body 122 and the radiator 140 (hereinafter referred to as the “reference contact surface”) is equivalent to the product of the length L1 of the side of the supporting body 122 along the left/right direction and the length L2 of the side of the supporting body 122 along the up/down direction.

With respect thereto, according to the present embodiment, the contact surface area between the supporting body 22 and the radiator 40 is equivalent to the surface area of the back surface 26 of the supporting body 22. The plurality of protrusions 26a are formed on the back surface 26 and the surface area thereof is larger than the surface area of the reference contact surface.

According to the motor-driving device 10 of the present embodiment, the radiator 40 is detachably attached to the supporting body 22. Accordingly, the radiator 40 of the motor-driving device 10 alone can be separated to carry out maintenance and inspection thus improving the operability.

Further, according to the present embodiment, in order to increase the surface area of the contact surface between the supporting body 22 and the radiator 40, the protrusions 26a and the recesses 26b; and the protrusions 44a and the recesses 44b are formed on the back surface 26 of the supporting body 22 and the front surface 44 of the radiator 40 respectively. As a result, the heat resistance between the supporting body 22 and the radiator 40 decreases and the heat generated by the power element 20 is efficiently transmitted to the radiator 40. Accordingly, the cooling operation for cooling the power element 40 is improved, overheating of the motor-driving device 10 can be prevented and breakage of the power element 20 as a result of the heat generated can be prevented.

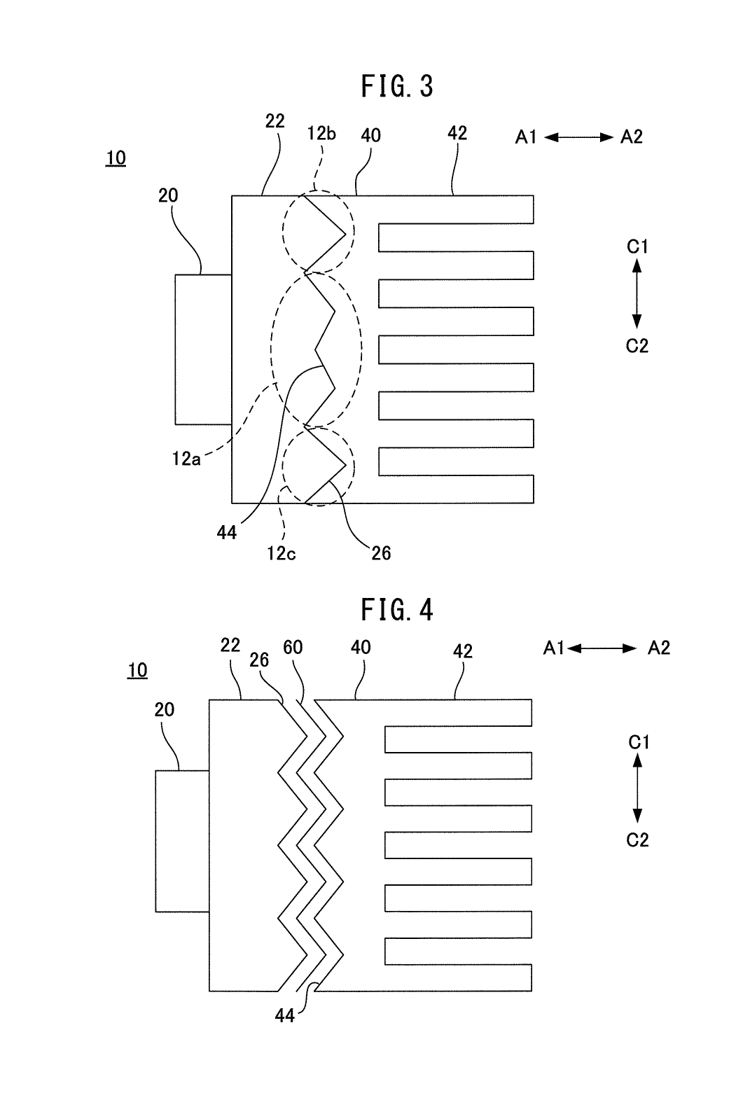

The motor-driving device 10 according to another embodiment will be described with reference to FIG. 3. In the motor-driving device 10 according to the present embodiment, the surface area of the contact surface between the supporting body 22 and the radiator 40 changes in accordance with the distance from the power element 20. Namely, of the contact areas, the increase in surface area of the first area 12a positioned directly behind the power element 20 is limited to be comparatively small. Whereas, the increase in the surface areas of the second area 12b and the third area 12c which are positioned in positions deviated in the upward and downward directions from the power element 20 are larger than the increase in the contact area of the first area 12a.

According to the present embodiment, the supporting body 22 and the radiator 40 are formed such that the greater the distance from the power element 20, the greater the increase in surface area. Accordingly, the heat resistance is reduced between the supporting body 22 and the radiator 40 in the second area 12b and the third area 12c which are positioned away from the power element 20. As the transmission paths of heat generated from the power element 20 are distributed throughout the supporting body 20, localized heat increases are prevented and the heat is efficiently transmitted to the radiator 40.

Note, as shown in FIG. 3, that by adjusting the protruding amount of the protrusions on the opposed surface of the supporting body 22 and the radiator 40, the surface area of the contact surface may be increased or decreased. In another embodiment, the number of protrusions may be changed in order to adjust the surface area of the contact surface.

FIG. 4 illustrates the motor-driving device 10 according to another embodiment. In this embodiment, an intermediate body 60 is provided between the supporting body 22 and the radiator 40. The intermediate body 60 is formed to correspond to the shape of the back surface 26 of the supporting body 22 and the front surface 44 of the radiator 40.

The intermediate body 60 is made of a material with higher heat conductivity than air. In one embodiment, the intermediate body 60 may be an elastic material so that it can be snugly fitted to the supporting body 22 and the radiator 40. In a specific embodiment, the intermediate body 60 is formed of a resin such as silicone.

By providing the intermediate body 60 between the supporting body 22 and the radiator 40, an effect of reducing the heat resistance therebetween can be obtained. According to this embodiment, unlike the use of a liquid adhesive with heat conductivity, there is no need to remove the adhesive. Therefore, the radiator 40 can be easily detached from the supporting body 22.

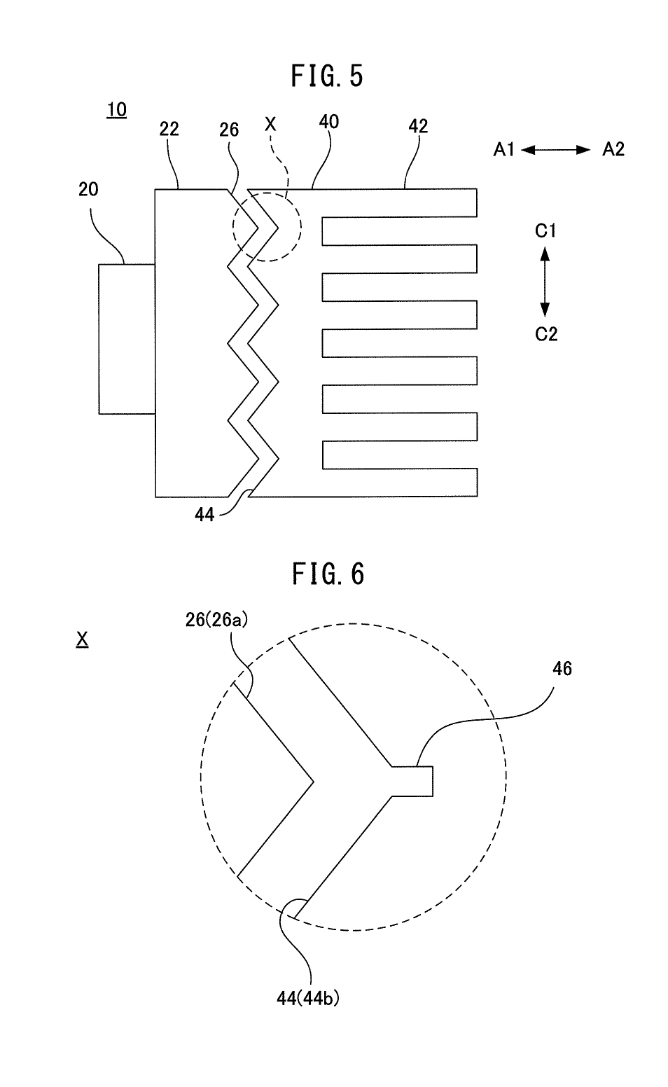

The motor-driving device 10 according to a different embodiment will be described with Reference to FIG. 5 and FIG. 6. FIG. 6 is a partially enlarged view of the area X enclosed by the broken line in FIG. 5.

According to the present embodiment, the recesses 44b of the front surface 44 of the radiator 40 have formed therein grooves 46 recessed in the backward direction. Each of the grooves 46 forms a gap between the back surface 26 of the supporting body 22 and the supporting body 22. When a liquid heat-conductive material is applied to the back surface 26 of the supporting body 22 or the front surface 44 of the radiator 40, surplus heat-conductive material flows out through the grooves 46. The grooves 46 also contribute to the removal of air bubbles contained in the heat-conductive material. Furthermore, when the radiator 40 is detached, air enters the grooves 46 thus requiring even less effort to remove the radiator 40. Alternatively, even when a solid heat-conductive material (namely intermediate body 60) is used, as shown in FIG. 4, the grooves 46 are effective at removing air bubbles which have entered the gap between the supporting body 22 and the radiator 40.

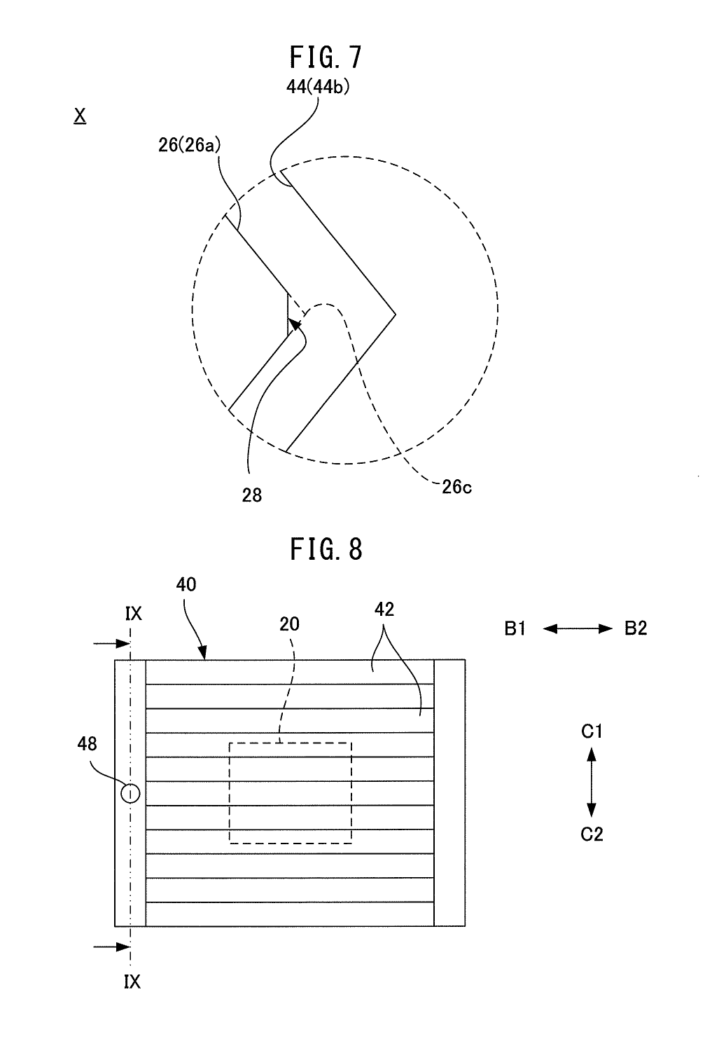

FIG. 7, like FIG. 6 is an enlarged view of the region X of FIG. 5. In this embodiment, instead of the grooves 46, the top portions 26c of the protrusions 26a of the supporting body 22 are cut out to form chamfers 28. A gap is formed between the supporting body 22 and the radiator 40 by each chamfer 28. The gap formed by the chamfer 28 functions in the same way as the grooves 46 as a flow-out passage for surplus heat-conductive material and air bubbles. The grooves 46 or the chamfers 28 may be formed in either the radiator 40 or the supporting body 22 or both.

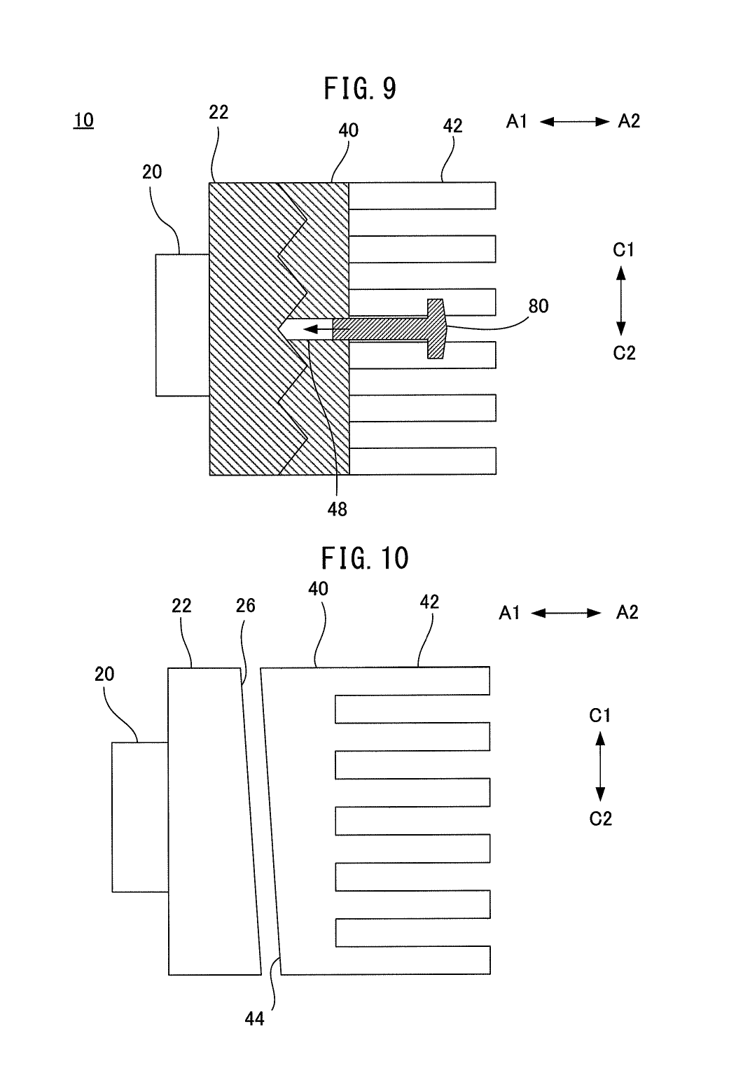

The motor-driving device 10 according to another embodiment will be described with reference to FIG. 8 and FIG. 9. FIG. 8 is an end view as seen from behind the motor-driving device 10, and FIG. 9 is a sectional view along the line IX-IX in FIG. 8.

According to this embodiment, a threaded hole 48 is formed on the left edge of the radiator 40. FIG. 8 shows that the threaded hole is formed in a position deviated to the left of the power element 20 and is formed in an area where the fins 42 are not formed. Note that the illustrated position and the number of the threaded holes 48 is an example and are not specifically limited thereto. The threaded hole 48 extends through the radiator 40 in the front/back direction. On the other hand, the supporting body 22 does not have a hole formed therein. Therefore, when the radiator 40 is attached to the supporting body 22 as shown in FIG. 9, the threaded hole is closed by the supporting body 22.

The threaded hole 48 is used to assist in the process of detaching the radiator 40 from the supporting body 22. As shown in FIG. 9, when a screw 80 is inserted into the threaded hole 48 and moved in the forward direction, the tip of the screw 80 abuts the supporting body 80. Moreover, by further advancing the screw 80 toward the supporting body 22, the counter force received from the supporting body 22 separates the radiator 40 from the supporting body 22.

Such a configuration for assisting the step of detaching the radiator 40 is particularly effective when a heat-conducting material is provided between the supporting body 22 and the radiator 40. Namely, the heat conducting material, like an adhesive, brings the supporting body 22 and the radiator 40 into close contact with each other, and accordingly a large force may be required to detach the radiator 40 from the supporting body 22. According to the present embodiment, by using threaded hole, the radiator 40 can be easily separated from the supporting body 22 and the efficiency of maintenance and inspection can be improved.

FIGS. 10 to 12 illustrate a motor-driving device 10 according to different embodiments. In the motor-driving device 10 illustrated in FIG. 10, the back surface 26 of the supporting body 22 is inclined at a certain angle with respect to the up/down direction. The radiator 40 has a complementary shape to the supporting body 22 and the front surface 44 of the radiator 40 is inclined with respect to the up/down direction in the same way as the back surface 26 of the supporting body 22.

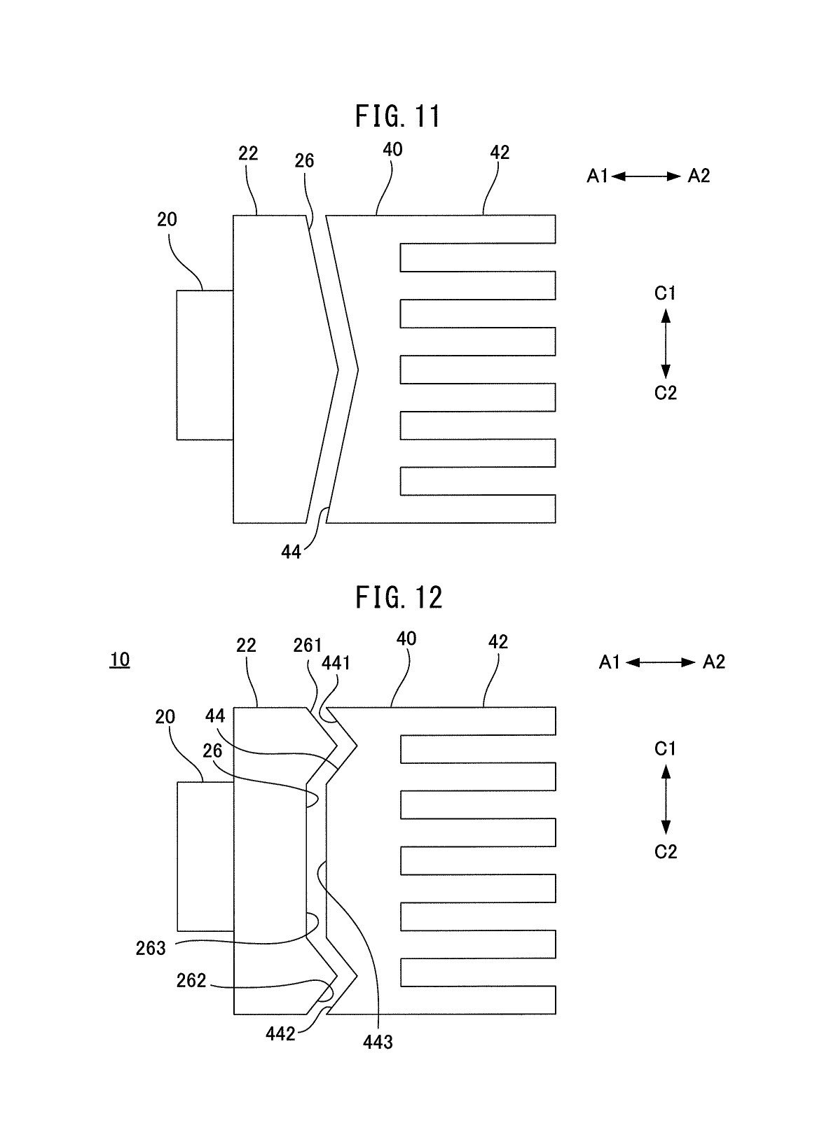

In the motor-driving device 10 illustrated in FIG. 11, the back surface 26 of the supporting body 22 is formed to protrude in the backward direction as a whole. The front surface 44 of the radiator 40, so as to correspond to the back surface 26 of the supporting body 22, is recessed in the backward direction.

In the motor-driving device 10 illustrated in FIG. 12, the back surface 26 of the supporting body 22 consists of an upper first area 261, a lower second area 262 and a third area 263 positioned between the first area 261 and the second area 262.

The first area 261 and the second area 262 have protrusions which protrude in the backward direction, whereas, the third area 263 forms a plane extending in a direction perpendicular to the forward and backward directions.

The radiator 40 has a complementary shape to the supporting body 22 and consists of a first area 441 and a second area 442 which are recessed in the backward direction and a third area 443 forming a plane extending in a direction perpendicular to the forward and backward directions.

In this way, in the embodiment illustrated in FIG. 12, areas which are within a short distance from the power element 20, namely the third areas 263, 443 are not configured to increase the contact surface area.

In each of the embodiments illustrated in FIGS. 10 to 12, when compared to the Comparative Example of FIG. 14, at least a part of the surface area of the contact area between the supporting body 22 and the radiator 40, is increased. Therefore, the heat radiation property is improved.

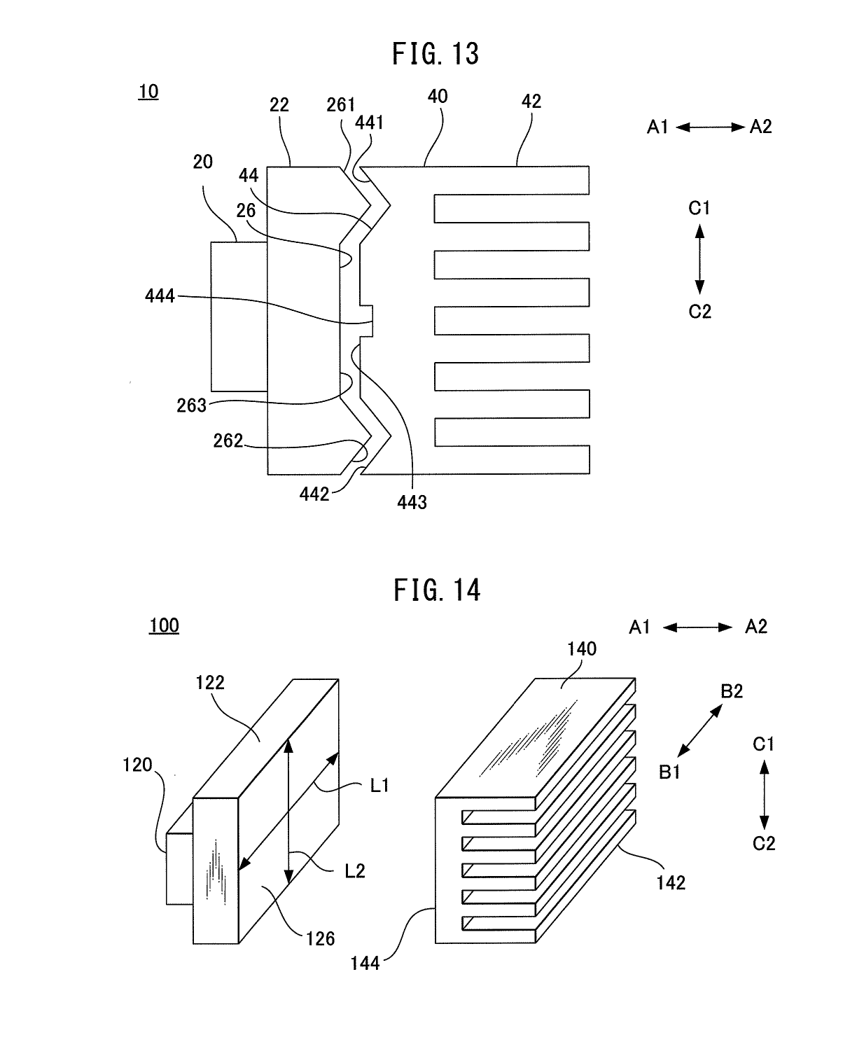

FIG. 13 illustrates a motor-driving device 10 according to another embodiment. According to this embodiment, a groove 444 recessed in the direction opposite the supporting body 22 is formed in the front surface 44 of the radiator 40. The dimensions of the groove 444 are determined so as to allow a tool such as a minus screwdriver to be accepted. Accordingly, by using the tool inserted into the gap formed by the groove 444, the radiator 40 can be separated from the supporting body 22. Hence the radiator 40 can be easily detached from the supporting body 22. Such a groove 444 may be formed in the back surface 26 of the supporting body 22, or on both the front surface 44 of the radiator 40 and the back surface 26 of the supporting body 22.

Above, the radiator 40 configured to radiate heat generated from the power element 20 of the motor-driving device 10 has been described. However, according to another embodiment, the radiator 40 may be used to cool a heat source in the motor-driving device other than the power element 20.

The protrusions 26a and 44a formed respectively on the back surface 26 of the supporting body 22 and the front surface 44 of the radiator 40 may be formed in a separate process from the process forming the main body such as by cutting, or may be formed by the same process such as by molding.

### The Effect of the invention

According to the motor-driving device of the present invention, the opposing faces of the radiator and the supporting body are formed to increase the surface area of the contact surface between the radiator and the supporting body. Accordingly, a sufficient amount of heat can be transmitted to the radiator from the supporting body and the heat-radiating function can be improved.

Above, various embodiments of the present invention have been described. However, it could be recognized by a person skilled in the art that the intended effects of the invention may be brought about by other embodiments. Specifically, without departing from the scope of the present invention, the constitutional elements of the aforementioned embodiments may be removed or replaced, or a well-known means may be added. Further, it would be obvious to a person skilled in the art that the features of the plurality of embodiments, explicitly or implicitly disclosed in the specification of the present invention, may be combined to carry out the present invention.

1. A motor-driving device comprising:
a heat source;
a supporting body which supports the heat source and is formed of a heat conductive material;
a radiator which is detachably attached to the supporting body and which radiates heat transmitted through the supporting body from the heat source;
wherein the surface area of the contact surface between the supporting body and the radiator is larger than the surface area of a reference contact surface when the supporting body contacts the radiator, in a plane extending in a direction perpendicular to the attaching direction of the radiator.

2. The motor-driving device according to claim 1, wherein the surface area of the contact surface, over the whole contact surface, is larger than the surface area of the reference contact surface.

3. The motor-driving device according to claim 1, wherein the increase in surface area of the contact surface with respect to the surface area of the reference contact surface changes in accordance with the distance from the heat source.

4. The motor-driving device according to claim 1, further comprising an intermediate body which is formed of a material with a heat conductivity higher than air and which is provided between the supporting body and the radiator.

5. The motor-driving device according to claim 4, wherein the intermediate body is formed of a solid material.

6. The motor-driving device according to claim 1, wherein a gap is formed in the contact surface by a recess formed on at least one of the supporting body and the radiator.

7. The motor-driving device according to claim 1, wherein a threaded hole is formed which extends through the radiator in the attaching direction but does not extend through the supporting body.
